(19) United States
(12) Patent Application Publication
(10) Pub. No.: US 2014/0214449 A1
(43) Pub. Date: Jul. 31, 2014

(54) SYSTEM AND METHOD FOR POWERING, COMMUNICATING, AND STORING DATA FOR ACCESSORY DEVICES USING A DEVICE UTILIZATION SYSTEM

(71) Applicant: Proventix Systems, Inc., Birmingham, AL (US)

(72) Inventors: Avery Dallas Long, Madison, AL (US); Harvey A. Nix, Birmingham, AL (US); Romeo Maurice Burtis, Birmingham, AL (US)

(73) Assignee: Proventix Systems, Inc., Birmingham, AL (US)

(21) Appl. No.: 14/343,690

(22) PCT Filed: Sep. 27, 2012
(86) PCT No.: PCT/US2012/057575

§ 371 Date: Mar. 7, 2014

Related U.S. Application Data
(60) Provisional application No. 61/539,725, filed on Sep. 27, 2011.

(51) Int. Cl. G06F 19/00; G06Q 50/22; G06Q 10/06

(52) U.S. Cl. CPC G06F 19/327; G06Q 10/06; G06Q 50/22
USPC 705/2

(57) ABSTRACT

The present disclosure relates to a system and method for providing a power source, a communications link, and data storage for accessory devices. In a preferred embodiment, a control unit of a hand hygiene compliance system provides a power source, a communications link, and data storage for accessory devices in a room or area of a healthcare facility. In this particular embodiment, the control unit receives power from an offline power source and has a communications module to communicate with a server over a communications network associated with the hand hygiene compliance system. Also, the control unit is further comprised of a port for DC power and data communications that is accessible to accessory devices. As follows, upon receiving data from an accessory device via the port, the control unit is operable to communicate data to the server for storage on a database.

### PRIORITY CLAIM

This application claims priority to and the benefit of U.S. provisional patent application No. 61/539,725 filed 27 Sep. 2011.

### TECHNICAL FIELD

The present disclosure relates to the use of a system for detecting and identifying use of a monitored device to provide a power supply, a communications network, and data storage for a plurality of accessory devices.

### BACKGROUND ART

In many industries, it is desirable to implement accessory devices operable to collect and communicate data for a variety of purposes. For example, healthcare facilities routinely seek accessory devices capable of monitoring and communicating temperature values associated with refrigeration units housing perishable supplies. While there are accessory devices operable to meet this need, each device requires use of a facility's network. Accordingly, in an effort to overcome this limitation, accessory devices are assigned a channel on the facility's network. However, as the number of accessory devices on a channel increases, a reduction in the flow of data across the channel occurs. This creates delays associated with communicating data which becomes problematic for accessory devices operable to communicate data at a high rate. Therefore, there is a need for a system having a network operable to support a plurality of accessory devices without compromising the functionality of the network.

Another challenge associated with implementing accessory devices in a facility relates to power. Unless the accessory devices are battery powered, the facility must provide a power supply to power said devices. As such, depending on the number of accessory devices being installed, a facility may incur substantial costs associated with the time and labor necessary to provide additional power. Therefore, there is a need for a system operable to distribute an already existing power supply to the accessory devices, thereby eliminating the need for a facility to run additional lines for power. Still further, yet another challenge associated with implementation of accessory devices in a facility relates to data storage. Accessory devices require use of a server on the facility's network operable to store data. Therefore, there is a need for a system operable to store data for accessory devices on a single server, thereby eliminating the need for additional servers.

While the discussion thus far has focused on the shortcomings of accessory devices operable to collect and communicate data, facilities continue to incur substantial costs associated with the installation of these devices, because the value of the data they obtain outweighs those substantial costs. Accordingly, there is a need for a system operable to eliminate each of the challenges mentioned above providing a more affordable and less burdensome solution for implementing accessory devices in a facility.

### DISCLOSURE OF THE INVENTION

Embodiments of the present disclosure relate to the use of a system for detecting and identifying use of a monitored device by accessory devices. More specifically, the present disclosure relates to a use of the system, wherein the system provides a power supply, a communications network, and data storage which accessory devices may use, further reducing the cost and time associated with implementing accessory devices in a facility. In an exemplary embodiment, a hand hygiene compliance (HHC) system provides a power supply, a communications network, and data storage for a plurality of accessory devices. More specifically, the HHC system comprises a plurality of control units and a server to communicate with the control units over a communications network. The control units are operable to distribute a power supply from the HHC system to accessory devices and to communicate with accessory devices and the server. Accordingly, through the communications network, control units may communicate data from accessory devices to the server for storage in a database. Further, the control units are also equipped with a feedback device in the form of a small display operable to display data from the accessory devices and in some embodiments serves as an interface allowing a user to communicate with and manually configure parameters associated with the accessory device.

This embodiment and other embodiments of the present disclosure will become readily apparent to those skilled in the art from the following detailed description of the embodiments having reference to the attached figures, the disclosure not being limited to any particular embodiment(s) disclosed.

### BRIEF DESCRIPTION OF THE DRAWING

FIG. 1 is a schematic representation of one embodiment of a system for powering, communicating, and storing data for an accessory device in accordance with the present disclosure.

FIG. 2 is a detailed schematic of a system for powering, communicating, and storing data for a passive RFID reader in accordance with the present disclosure.

FIG. 3 is a detailed schematic of a system for powering, communicating, and storing data for a temperature sensor in accordance with the present disclosure.

### BEST MODE FOR CARRYING OUT INVENTION

The various embodiments of the present disclosure and their advantages may be understood by referring to the attached drawings. The elements of the drawings are not necessarily to scale, emphasis instead being placed upon illustrating the principles of preferred embodiments of the present disclosure. Throughout the drawings, like numerals are used for like and corresponding parts of the drawings. The present disclosure may be provided in other specific forms and embodiments without departing from the essential characteristics as described herein. Accordingly, the embodiments described below are considered in all aspects as illustrative only and not restrictive in any manner.

The present disclosure relates to a system for monitoring and identifying use of a monitored device, with the system further providing electrical power, a communications network, and data storage for a plurality of accessory devices. The system comprises a control unit, a feedback device, and a server in communication with the control unit over a communications network. The control unit is operable to distribute electrical power to accessory devices as well as communicate data from accessory devices to the server through the communications network. The feedback device displays data from the accessory devices and in some embodiments serves as an interface allowing a user to communicate with and manually configure parameters associated with the accessory devices. The server is operable to record data from the accessory devices and in some embodiments communicates data to an application server where the data may be hosted for a user, such as a facility administrator. As used herein, the term “accessory device” broadly refers to any device operable to collect data. Likewise, the term “feedback” device broadly refers to any visual, auditory, or tactile device capable of conveying information to a person, including displays associated with a control unit. Further, the basic components and operation of a system for monitoring and identifying use of a monitored device are known to those of ordinary skill in the art and will not be described in detail here.

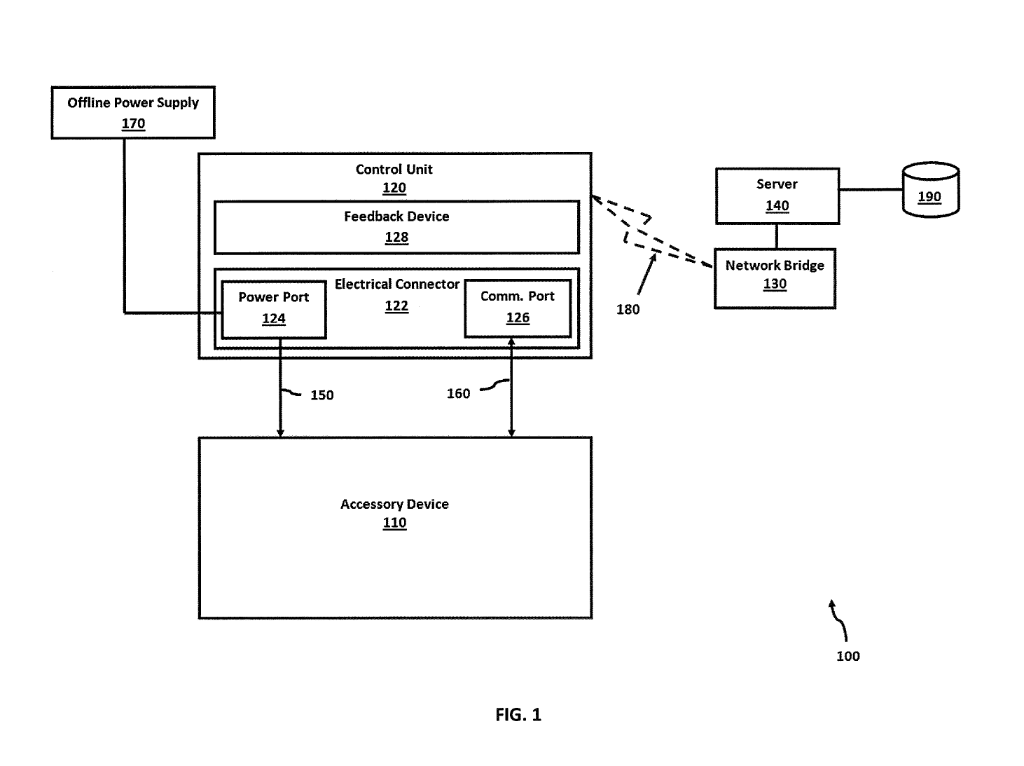

Referring now to FIG. 1, one embodiment of a hand hygiene compliance (HHC) system (100) operable to power, communicate, and store data for an accessory device (110) is shown comprising a control unit (120), a communications network comprising a network bridge (130), and a server (140). More specifically, an electrical connector (122) affixed to the control unit (120) comprises a power port (124) and a communications port (126), each being operable to interface with an accessory device (110). The power port (124) is operable to distribute electrical power to an accessory device (110), while the communications port (126) provides a communications link between the control unit (120) and an accessory device (110). Accordingly, in one embodiment, an accessory device (110) is coupled with the power port (124) and the communications port (126) by a first connection (150) and a second connection (160) respectively. Through the first connection (150), the control unit (120) distributes an offline electrical power supply (170) from a facility's power grid to the accessory device (110). Through the second connection (160), the control unit (120) detects and communicates with the accessory device (110), whereby the second connection (160) may be any wired or wireless communications link presently existing or developed hereafter, including by way of example universal serial bus (USB) link, universal asynchronous receiver/transmitters (UARTs), or inter-integrated communications (I²C) links and the like.

Still referring to FIG. 1, the control unit (120) is operable to detect an accessory device (110) coupled with the second port (126) each time the system (100) is initialized (i.e. startup), at other regularly defined intervals, or upon the occurrence of selected events. Moreover, once an accessory device (110) is detected, the control unit (120) initializes communications with the accessory device (110) over the second connection (160). The frequency of communications between the control unit (120) and the accessory device (110) may vary from one embodiment to another. In one embodiment, parameters relating to communications may be stored on a memory chip or other like device associated with the accessory device (110), whereby the control unit (120) is operable to read the memory chip and communicates parameters to the network bridge (130) or the server (140), which are further operable to communicate commands to the control unit (120) based at least in part upon parameters. Alternatively, in another embodiment, a user may manually assign an interval for communications using a feedback device (128) operable to receive and communicate operational parameters for an accessory device (110) to the server (140) via the network bridge (130). Accordingly, in one embodiment, a user may use the feedback device (128) to input a parameter requiring the control unit (120) to poll an accessory device (110) every hour for data. The server is operable to receive the parameter and communicate a command to the control unit (120) every hour to communicate with the accessory device (110) to collect data and communicate data back to the server (140). Additionally, the feedback device (128) is also operable to display data from the accessory device (110).

Still further, using the communications port (126), the accessory device (110) is operable to communicate data to the control unit (120). When the control unit (120) receives data from the accessory device (110) via the communications port (126), the data is communicated to the server (140) through a transmission (180) involving the communications network, including a wireless transmission with the network bridge (130). The network bridge (130) is any communications bridge, hub router, node, or other unit known in the art for transferring information over a network, in any network topology or architecture. Alternatively, the control unit (120) is operable to communicate data directly to a receiver communicatively coupled to the server (140). Moreover, once the server (140) receives data, a database (190) associated with the server (140) records data, with the server (140) in some embodiments further operable to communicate data from the database (180) to an application server where the data may be hosted for a user, such as a facility administrator.

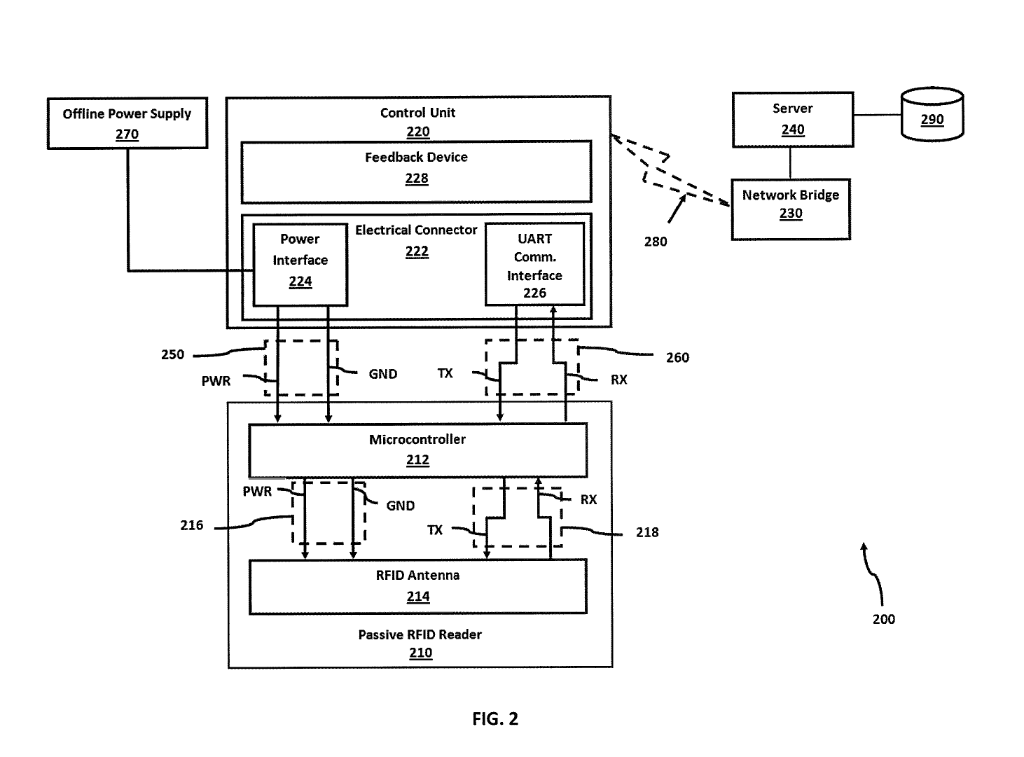

Referring now to FIG. 2, an exemplary embodiment of a HHC system (200) operable to provide power, communications, and data storage for a passive Radio Frequency Identification (RFID) reader (210) is shown, with the system comprising a control unit (220), a communications network comprising a network bridge (230), and a server (240). More specifically, an electrical connector (222) affixed to the control unit (220) comprises a power port (224) and a UART communications port (226), each being operable to interface with the RFID reader (210). The power port (224) is operable to distribute electrical power to the RFID reader (210), while the UART communications port (226) provides a communications link between the control unit (220) and the RFID reader (210). Accordingly, in one embodiment, the RFID reader (210) further includes a microcontroller (212) and an RFID antenna (214), the microcontroller (212) being coupled with the power port (224) and the UART communications port (226). More specifically, the power port (224) is coupled with the microcontroller (212) by a power wire (250) and a ground wire (252), with the power wire (250) distributing an offline electrical power supply (270) from a facility's power grid to the microcontroller (212). The UART communications port (226) is coupled with the microcontroller by a transmit wire (260) and a receive wire (262). Through the transmit wire (260), the control unit (120) transmits data or commands to the microcontroller (212). Likewise, the receive wire (262) allows the control unit (220) to receive data from the microcontroller (212). Still further, the microcontroller (212) is coupled with the RFID antenna (214) and operable to provide an electrical power supply (216) and a UART communications link (218) with the RFID antenna (214).

In one embodiment, the RFID antenna (214) is operable to read a unique identification code assigned to a tagged asset, such as a piece of equipment or a supply, and transmit the identification code to the microcontroller (212) over the UART communications link (218). Upon receiving the identification code, the microcontroller (212) transmits the identification code to the control unit (220), with the control unit (220) receiving the identification code via the receive wire (262) coupling the microcontroller (212) with the UART communications port (226). The control unit (220) then communicates the identification code to the server (240) through a transmission (280) involving the communications network, including a wireless transmission, with the network bridge (230). Upon receipt of the identification code, the server (240) records the identification code in a database (290) associated with the server (240). Still further, the server (240) is also operable to transmit commands back to the tagged asset via the RFID reader (210) based at least in part upon the identification code relating to the tagged asset. For example, in one embodiment, the RFID reader (210) transmits a command to an RFID tag associated with a catheter having been recently installed to deactivate the RFID tag to prevent a user from reusing the tag again on the catheter or another piece of equipment or supply. In yet another embodiment, the server (240) may communicate a procedure or set of procedures relevant to a tagged asset, such as a piece of equipment, on a feedback device (228) associated with the control unit (220) based at least in part upon the unique identification code read by the RFID reader (210).

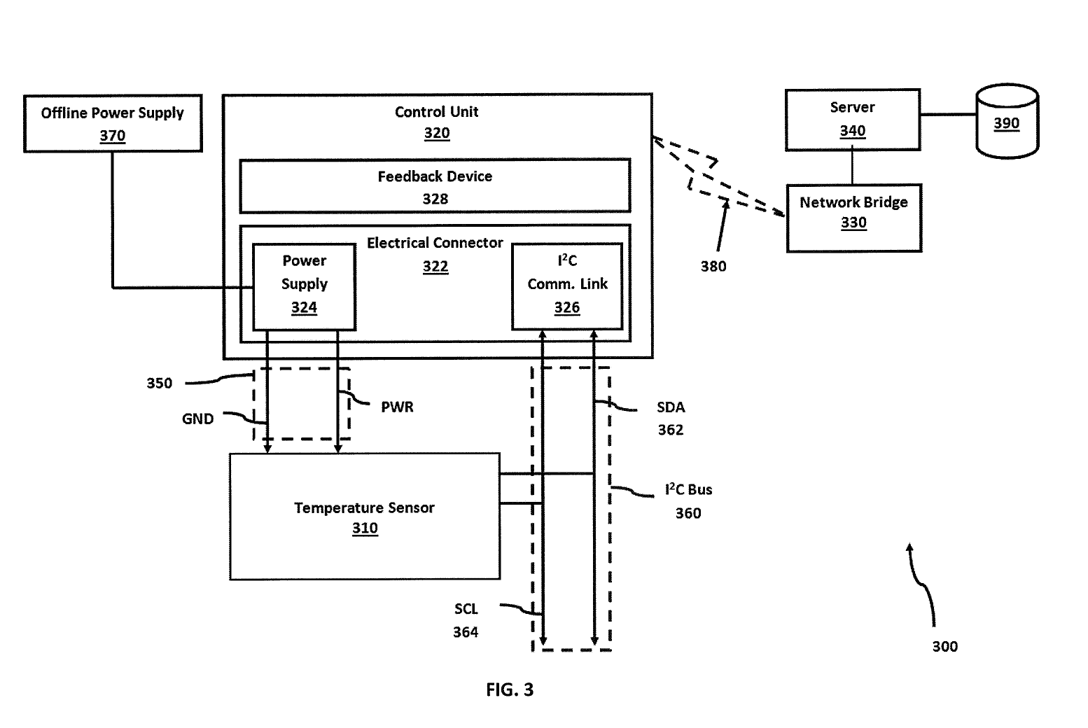

Referring now to FIG. 3, an exemplary embodiment of a HHC system (300) operable to provide power, communications, and data storage for a temperature sensor (310) is shown comprising a control unit (320), a communications network comprising a network bridge (330), and a server (340). More specifically, an electrical connector (322) affixed the control unit (320) comprises a power port (324) and an I²C communications port (326), each being operable to interface with the temperature sensor (310). The power port (324) is operable to distribute electrical power to the temperature sensor (310), while the I²C communications port (326) provides a communications link for the temperature sensor (310). Accordingly, in one embodiment, the temperature sensor (310) is coupled with the power port (324) and the communications port (326) by an electrical connection (350) and an I²C bus (360) respectively. Through the electrical connection (350), the control unit (320) is operable to distribute an offline electrical power supply (370) from a facility's power grid to the temperature sensor (310). Through the I²C bus (360), which comprises a serial data (SDA) line (362) and a serial clock (SCL) line (364), an I²C bus connection is provided for the temperature sensor (310) to couple thereto. Moreover, in one embodiment, the I²C bus (360) also includes an optional detection line for detecting the presence of an accessory device coupled thereto.

In an exemplary embodiment, the control unit (320) controls the I²C bus (360) and coordinates communications between the control unit (320) and the temperature sensor (310). Accordingly, the control unit initiates a communication transaction with the temperature sensor (310) over the I²C bus (360). This can be accomplished by the control unit (320) by addressing the temperature sensor (310) with a read/write access request. A start condition may be generated over the SDA line (362) by the control unit (320) to inform any other accessory devices coupled to the I²C bus (360) that a communication transaction is occurring. After the temperature sensor (310) acknowledges initiation of the communication transaction, the control unit (320) can send or receive data from the temperature sensor (310). Upon receiving data from the temperature sensor (310), the control unit (320) communicates data to the server (340) through a transmission (380), including a wireless transmission, with the network bridge (330). Upon receiving data, the data is stored in a database (390) associated with the server (340) and in some embodiments is communicated by the server (340) to an application server where data may be hosted for a user.

The control unit (320) further includes a feedback device (328) in the form of a small display operable to communicate data from the temperature sensor (310) to a user. Accordingly, the feedback device (328) may display a real-time temperature reading for a refrigeration unit housing a temperature sensor (310) coupled with the control unit (320). Still further, in another embodiment, the feedback device (328) is operable to display temperature readings from a temperature sensor (310) monitoring temperature of a patient's room or a monitored area in a facility. Accordingly, a temperature sensor (310) coupled with the control unit (320) in a patient's room is operable to dynamically display temperature readings on a feedback device (328) associated with the control unit (320).

Other embodiments of the present disclosure may include accessory devices, such as humidity sensors or ambient light sensors interfacing with a HHC system, whereby the HHC system provides power, communications and data storage capabilities for the accessory devices. For example, an HHC system may interface with a humidity sensor in a facility using a control unit to power and communicate data from the humidity sensor to a server via a communications network associated with the HHC system. Likewise, an HHC system may interface with an ambient light sensor using a control unit to power and communicate data from the ambient light sensor to a server via a communications network associated with the HHC system. More specifically, the HHC system may collect and store data relating to ambient light levels in a room or area of a facility and communicate data to a system in a facility operable to control lighting in the facility based at least in part upon data from the ambient light sensor. The HHC system may also display data from the humidity sensor or ambient light sensor on a feedback device associated with the control unit. For example, in one embodiment, the feedback device is operable to dynamically display humidity readings for a room or area. In another embodiment, the feedback is operable to display a message based at least in part upon data collected by the ambient light sensor informing an individual that the lights may be turned on or off in a room or area of the facility. Still further, similar to the embodiments previously mentioned, the communications link with the control unit and the humidity sensor or ambient light sensor may be any wired or wireless communications link presently existing or developed hereafter.

While an assortment of exemplary embodiments of the present disclosure have been disclosed for purposes of illustration, it is obvious that many modifications and variations could be made thereto. Accordingly, it is intended to cover all of those modifications and variations which fall within the scope of the present disclosure.

What is claimed is:

1. A method of providing a power source and a communications link to accessory devices in a room or area of a health care facility, the method comprising:
delivering power from an offline power source to a control unit of a hand hygiene compliance system, the control unit operable to detect tagged personnel and monitor use of a hand hygiene dispenser in proximity to the control unit;
providing a port on the control unit for DC power and data communications, wherein the port is accessible to accessory devices; and
connecting the control unit to a communications network associated with the hand hygiene compliance system.

2. The method of claim 1, further comprising receiving data from an accessory device via the port.

3. The method of claim 2, further comprising communicating data received from the accessory device to a server over the communications network.

4. The method of claim 3, further comprising displaying data on a password protected website that is accessible to authorized personnel.

5. An apparatus for providing a power source and a communications link to accessory devices in a room or area of a health care facility, the apparatus comprising:
a control unit of a hand hygiene compliance system supplied with power from an offline power source and having a communications module for communicating with a server over a communications network associated with the hand hygiene compliance system, the control unit comprising a port for DC power and data communications, wherein the port is accessible to accessory devices.

6. The apparatus of claim 5, wherein the control unit further comprises a feedback device operable to display data received from an accessory device via the port.

7. The apparatus of claim 6, wherein the accessory device is a temperature sensor and the feedback device is operable to display temperature readings for a room or area in which the temperature sensor is located.

8. The apparatus of claim 6, wherein a user can send commands to the accessory device via the feedback device.

9. The apparatus of claim 5, wherein the accessory device is an RFID reader operable to detect an identity code of a tagged asset and communicate the code to the communications module via the port.

10. The apparatus of claim 9, wherein the communications module communicates the identity code to the server via the communications network.

11. The apparatus of claim 10, wherein the server sends a command to the communications module based at least in part upon the identity code.

12. The apparatus of claim 11, wherein the communications module communicates the command to the RFID reader via the port.

13. The apparatus of claim 12, wherein, upon receiving the command, the RFID reader transmits a signal that deactivates an RFID tag associated with the tagged asset to prevent reuse of the RFID tag.

14. A hand hygiene compliance system for providing a power source, a communications link, and data storage for accessory devices in a room or area of a health care facility, the system comprising:
a control unit supplied with power from an offline power source, the control unit comprising a port for DC power and data communications, wherein the port is accessible to accessory devices; and
a server in communication with the control unit over a communications network associated with the hand hygiene compliance system, the server operable to store data the control unit receives from accessory devices via the port.

15. The hand hygiene compliance system of claim 14, wherein accessory devices are selected from the group consisting of:
(a) an RFID reader;
(b) a temperature sensor;
(c) an ambient light sensor; and
(d) a humidity sensor.
